(19) United States
(12) Patent Application Publication
(10) Pub. No.: US 2026/0146731 A1
(43) Pub. Date: May 28, 2026

(54) SWITCHLESS LAMP HOLDER

(71) Applicant: Rich Brand Industries Limited, Dongguan City (CN)

(72) Inventor: Toucai Huang, Dongguan City (CN)

(21) Appl. No.: 18/961,706

(22) Filed: Nov. 27, 2024

(51) Int. Cl. F21V 23/00; F21V 15/01; F21V 17/00; F21V 23/06

(52) U.S. Cl. CPC F21V 23/002; F21V 15/01; F21V 17/005; F21V 23/06

(57) ABSTRACT

The present invention relates to a switchless lamp holder, comprising a hook, an assisting hook and a retaining edge using together, thereby enabling to restrict the up and down position of a power cord while passing, and meanwhile the power cord is firmly mounted in a positioning slot through a first conducting plate and a second conducting plate so the power cord entering into the positioning slot can be firmly clamped. Therefore, when connecting the power cord, the position of the power cord can be restricted and strongly clamp the power cord, avoiding the power cord to separate from the first and second conducting plates to ensure the safe use of electricity.

### BACKGROUND OF THE INVENTION

The present invention relates to a switchless lamp holder, and more particularly to a switchless lamp holder capable of restricting a power cord to be positioned and firmly clamping the power cord to prevent the power cord to fall off when connecting to the power cord, thereby ensuring the electricity safety.

### DESCRIPTION OF THE RELATED ART

Accordingly, “Lamp holder” is a common electric appliance used in buildings, and the lamp holder has a variety of using types, such as, to be installed on the ceiling to be used as a ceiling lamp or configured as a desk lamp or floor lamp, etc. A prior art lamp holder is to have two poles connected to the two poles of a power cord and the power cord is further connected to the mains electricity. A switch is installed at the middle of the power cord to control the electric conduction between the lamp holder and the mains electricity. A joining part (such as a threaded opening) is installed inside the lamp holder for mounting a lighting component (such as a bulb). When the lighting component is fitted into the joining part, the two poles of the lighting component will be electrically connected with the two poles of the lamp holder, and thereby the switch can be used to control lighting component on the lamp holder to light up and light out. The said lamp holder is called as a “switchless lamp holder”.

The development of the structure of the prior art switchless lamp holder is related to that in early days, the electric power was connected by winding the threads around a conducting wire, and then, the electric power was connected more conveniently in a manner of stripping and inserting the end of the conducting wire. However, currently the known drawback is that the end of the conducting wire is stripped to become the bare wire section having a smooth surface, and a bent plate is configured inside the lamp holder to snap with the bare wire section, thereby pressing the bent plate not to fall out. The bent plate does not provide a structure for reinforcing the snapping function so even though the bare wire section of the end of the power cord and the bent plate can achieve the snapping function initially, the power cord will easily separate from the bent plate while being pulled, to result in inconvenient inspection and repair.

### SUMMARY OF THE INVENTION

In view of the above drawback, the present invention is further researched and improved. Therefore, it is a primary objective of the present invention to provide a switchless lamp holder restricting the power cord to be positioned and strongly holding power cord to prevent the power cord falling off when the power cord is plugged into the lamp holder for connecting electricity, thereby ensuring electricity safety.

To achieve the above-mentioned objective, the present invention is to provide a switchless lamp holder, comprising a main casing, a cover casing, a first conducting plate, and a second conducting plate, wherein, the main casing is composed of a non-conductive material, with a pair of hooks vertically configured on its top, the front edge on the bottom of the hook is formed with an assisting hook, on the top surface of the main casing, a retaining edge is configured correspondingly in front of the hook, beside each hook, a catching slot is configured, on the top surface of the main casing, a pair of convex positioning blocks is configured next to the peripheral edge, each positioning block is configured with a downward through hole, the bottom of the main casing is hollowed out to form a space, on the wall of the space, a pair of holding thin slots is correspondingly configured in interlaced distribution, and a pair of lateral thread convex bodies is correspondingly configured, the threads of the corresponding thread convex bodies are continuous, and a positioning slot is formed under each plug hole.

The cover casing is composed of a non-conductive material, a downward through connecting slot is configured in the middle of the top edge, the bottom of the cover casing is hollowed out downward to form a space, a pair of downward-extending catching bars is vertically configured inside the space on the two sides of the connecting slot, the bottom end of the catching bars is formed with a catching hook, the catching bars and the above-mentioned catching slot are corresponding to each other, the bottom edge of the cover casing is correspondingly configured with a pair of positioning slots, the positioning slots are corresponding to the above-mentioned positioning blocks, to assemble the cover casing with the main casing, align the space on the bottom of the cover casing to the top of the main casing, and make adjustment so that the positioning slot of the cover casing is aligned to the positioning blocks of the main casing, and the catching bars of the cover casing is inserted into the catching slot of the main casing, then, the catching hook on the bottom of the catching bars will be hooked on the wall of the catching slot, and the cover casing and the main casing will be firmly coupled.

The first conducting plate is composed of a conductive material, having a slightly tilted clamping section, the middle of its front end is configured with a concave contact slot, its tail end is bent downward to form a contact section, its middle part tilts backward to form a middle tilted plate, and the two sides tilt forward to form a lateral tilted plate, the bottom end of the contact section tilts forward to form a first connecting section, its two sides respectively tilt downward to form a lateral tilted plate, the tail end of the first connecting section is bent downward to form a second connecting section, its two sides respectively tilt forward to form a lateral tilted plate, the bottom edge of the second connecting section tilts backward and then extends vertically downward to form a conducting plate, a pair of conducting flanges protruding backward is formed on its surface, the bottom edge of the conducting plate tilts forward and then extends vertically downward to form a bottom section, the two sides of its bottom edge respectively extend out to form a pressing plate, during assembly, the first conducting plate is pushed in from the space inside the main casing along a corresponding holding thin slot on the wall, so that the clamping section, contact section, first connecting section, and second connecting section of the first conducting plate are all pushed into the positioning slot and fixed on the internal wall, the pressing plate extended from the two sides of the bottom section can be clasped on the two side wall of the holding thin slot, thus, the first conducting plate can be fixed, the clamping section of the first conducting plate is suspended in the upper space of the positioning slot, the conducting plate and the conducting flanges are extended into the space of the main casing.

the second conducting plate is composed of a conductive material, having a slightly tilted clamping section, the middle of its front end is configured with a concave contact slot, its tail end is bent downward to form a contact section, its middle part tilts backward to form a middle tilted plate, and the two sides respectively tilt forward to form a lateral tilted plate, the bottom end of the contact section tilts forward to form a first connecting section, its two sides respectively tilt downward to form a lateral tilted plate, the tail end of the first connecting section is bent downward to form a second connecting section, the bottom edge of the second connecting section tilts backward to form a conducting plate, a conducting flanges protruding downward is formed on its surface, during assembly, the second conducting plate is pushed in from the space inside the main casing along the other corresponding holding thin slot on the wall, so that the clamping section, contact section, first connecting section, and second connecting section of the second conducting plate are all pushed into the other positioning slot and are clasped on the internal wall, the conducting plate and conducting flanges enter the space of the main casing.

According to the above-mentioned switchless lamp holder, the periphery of the top of the main casing is configured with a concave shield, the concave shield is disconnected when meeting the positioning blocks, the periphery of the bottom of the cover casing is configured with a positioning shield, the positioning shield is disconnected when meeting the positioning slot, when the cover casing and the main casing are joint, the concave shield and the positioning shield fit with each other.

According to the above-mentioned switchless lamp holder, a pair of through slots is configured on the cover casing on the outer side of the catching bars, to allow a tool to go through the through slot and apply a force to release the catching bars from the catching slot, so as to separate the cover casing from the main casing.

For better understanding of the technical means to accomplish the above object and the effect of the present invention, detailed descriptions are provided below with respect to the following embodiment.

### BRIEF DESCRIPTION OF THE DRAWINGS

FIG. 1 is a perspective view of the present invention.

FIG. 2 is exploded perspective view 1 of the main casing and cover casing of the present invention.

FIG. 3 is exploded perspective view 2 of the main casing and cover casing of the present invention.

FIG. 4 is exploded perspective view 3 of the main casing and cover casing of the present invention.

FIG. 5 is perspective view 1 of the first conducting plate in the present invention.

FIG. 6 is perspective view 2 of the first conducting plate in the present invention.

FIG. 7 is perspective view 1 of the second conducting plate in the present invention.

FIG. 8 is perspective view 2 of the second conducting plate in the present invention.

FIG. 9 is a sectional view of the present invention showing plug and connection of the power cord.

FIG. 10 is a partial sectional view of the present invention showing the joint between the main casing and the cover casing.

FIG. 11 is a sectional view of the present invention showing a variation with an external thread section and a locking component.

FIG. 12 is a combined view of the present invention showing a variation with an external thread section, a plate body, and a locking component.

### DETAILED DESCRIPTION OF EMBODIMENTS OF THE INVENTION

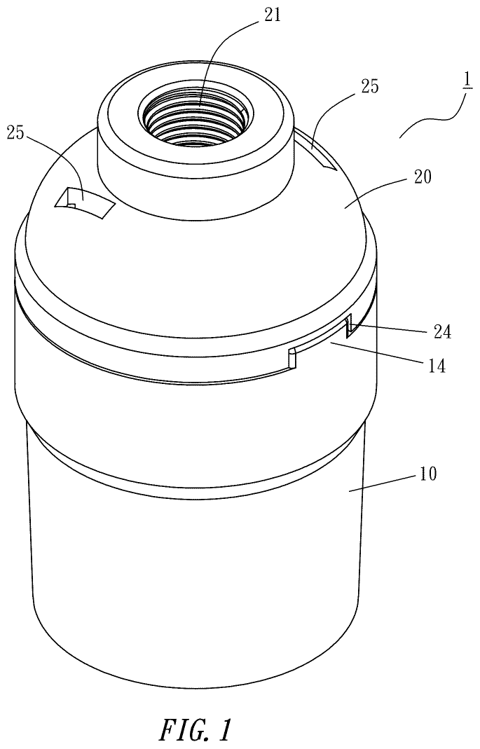

With reference to FIGS. 1 to 4, the present invention is a switchless lamp holder 1, comprising a main casing 10, a cover casing 20, a first conducting plate 30, and a second conducting plate 40.

The main casing 10 and the cover casing 20 are both of a non-conductive material. The periphery of the top surface of the main casing 10 is configured with a ring-shaped concave shield 101. The top surface is vertically configured with a pair of hooks 11. The hook bodies of the pair of hooks 11 are opposite each other. The front edge of the bottom of the hook body is formed with an assisting hook 111. A retaining edge 12 is configured on the top surface of the main casing 10 in front of the corresponding hook 11. A catching slot 13 is configured beside each hook 11. A pair of positioning blocks 14 is configured on the top surface of the main casing 10 next to the peripheral edge. The ring-shaped concave shield 101 is disconnected when meeting the positioning blocks 14. On each positioning block 14, a downward through hole 15 is configured. The inside of the main casing 10 is hollowed out in the downward direction to form a space 16. On the internal wall of the space 16, a pair of holding thin slot 17 is configured. Correspondingly, a pair of lateral thread convex bodies 18 is provided. The threads between the pair of thread convex bodies 18 are continuous. Under each plug hole 15, a positioning slot 19 is formed.

The top edge of the cover casing 20 is in a conic shape. A downward going connecting slot 21 is configured in the middle of the top edge. Inside the connecting slot 21, internal threads are provided. A positioning shield 201 is provided on the periphery of the bottom of the cover casing 20. The positioning shield 201 and the above-mentioned concave shield 101 are corresponding to each other. The inside of the cover casing 20 is hollowed out downward to form a space 22. A pair of downward-extending catching bars 23 is vertically configured inside the space 22 on the two sides of the connecting slot 21. The bottom end of the catching bars 23 is formed with a catching hook 231. The catching bars 23 and the above-mentioned catching slot 13 are corresponding to each other. The bottom edge of the cover casing 20 is correspondingly configured with a pair of positioning slots 24. The positioning slots 24 are corresponding to the above-mentioned positioning blocks 14. Therefore, the positioning shield 201 is disconnected when meeting the positioning slot 24. The cover casing 20 is configured with a pair of through slots 25 on the outer side of the catching bars 23.

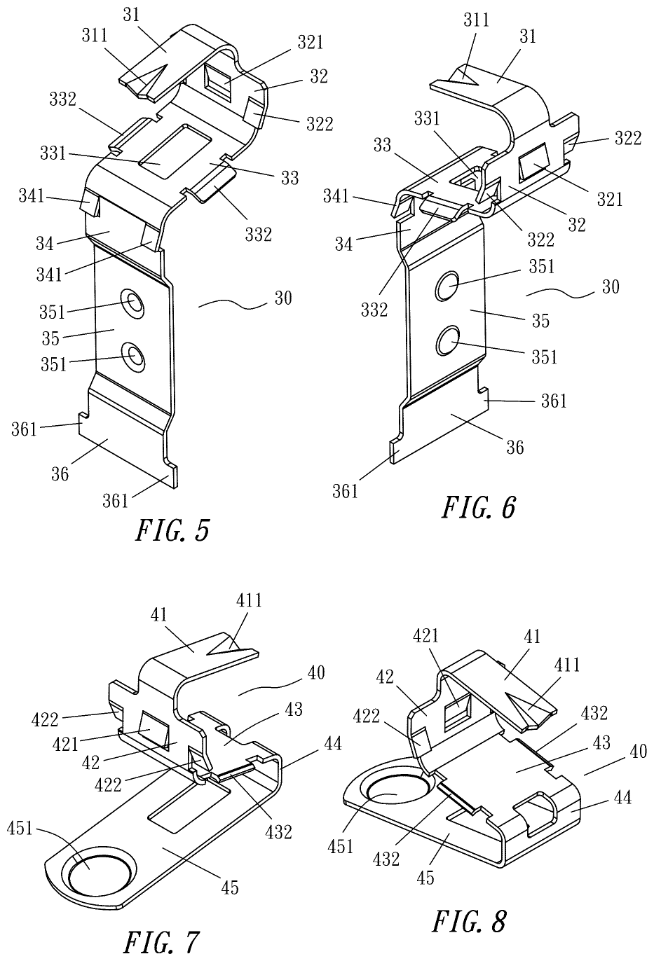

The first conducting plate 30 and the second conducting plate 40 are both a plate body of a conductive material formed through bending and pressing processes. As shown in FIGS. 5 and 6, from top to bottom, the first conducting plate 30 has a slightly tilted clamping section 31. The middle of its front end is configured with a concave contact slot 311 to reinforce the pressured contact. Its tail end is bent downward to form a contact section 32. Its middle part tilts backward to form a middle tilted plate 321 to reinforce the catching, and the two sides respectively tilt forward to form a lateral tilted plate 322 to reinforce the catching. The bottom end of the contact section 32 tilts forward to form a first connecting section 33, having a hollowed part 331 in the middle. Its two sides respectively tilt downward to form a lateral tilted plate 332 to reinforce the catching. The tail end of the first connecting section 33 is bent downward to form a second connecting section 34. Its two sides respectively tilt forward to form a lateral tilted plate 341 to reinforce the catching. Then, the bottom edge of the second connecting section 34 tilts backward and then extends vertically downward to form a conducting plate 35. A pair of conducting flanges 351 protruding backward is formed on its surface. The bottom edge of the conducting plate 35 tilts forward and then extends vertically downward to form a bottom section 36. The two sides of its bottom edge respectively extend out to form a pressing plate 361.

As shown in FIGS. 7 and 8, from top to bottom, the second conducting plate 40 firstly has a slightly tilted clamping section 41. The middle of its front end is formed with a concave contact slot 411 to reinforce the pressured contact. Its tail end is bent downward to form a contact section 42. Its middle part tilts backward to form a middle tilted plate 421 to reinforce the catching, and its two sides respectively tilt forward to form a lateral tilted plate 422 to reinforce the catching. The bottom end of the contact section 42 tilts forward to form a first connecting section 43. Its two sides respectively tilt downward to form a lateral tilted plate 432 to reinforce the catching. The tail end of the first connecting section 43 is bent downward to form a second connecting section 44. Then, the bottom edge of the second connecting section 44 tilts and extends backward to form a conducting plate 45. A conducting flanges 451 protruding downward is configured on its surface.

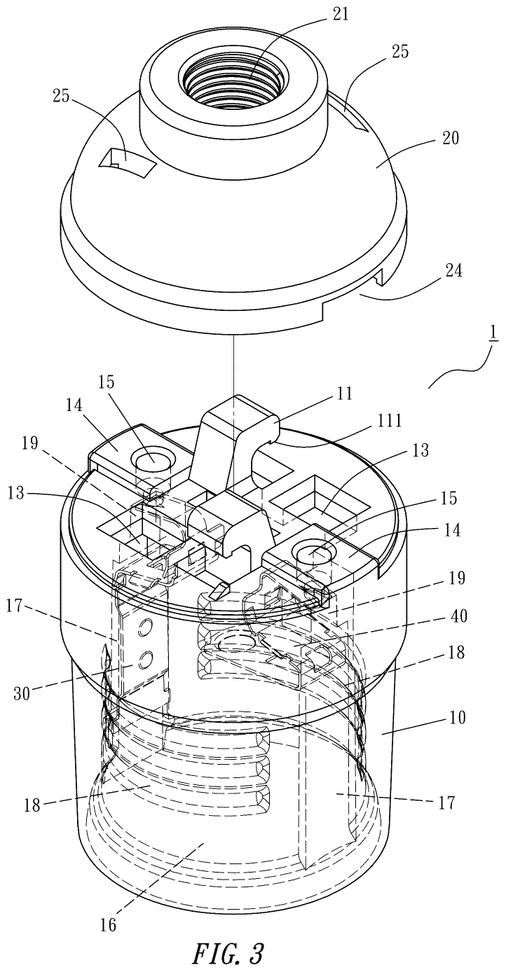

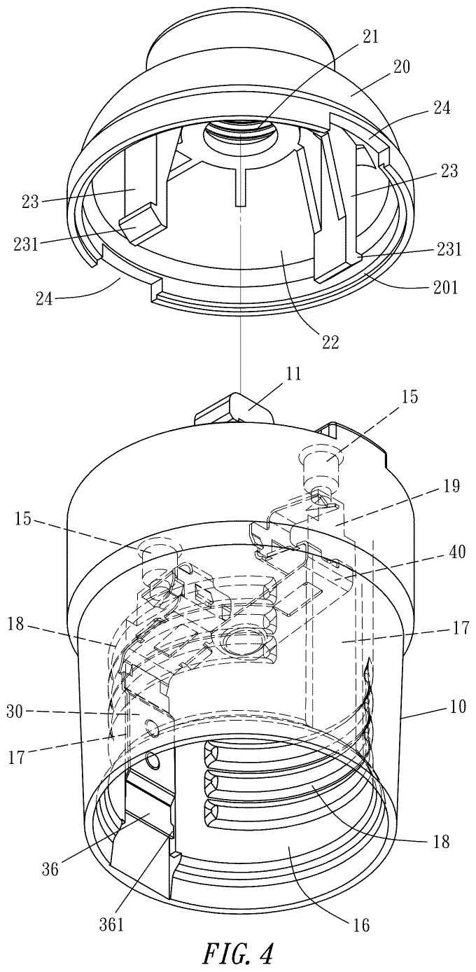

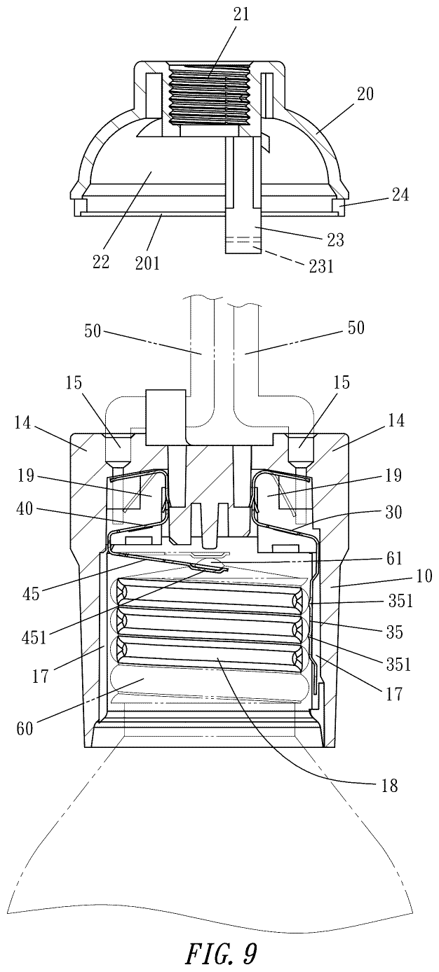

The assembly of the switchless lamp holder 1 is shown in FIGS. 3, 4 and 9. Initially, the main casing 10 and the cover casing 20 are separated from each other. Then, the first conducting plate 30 is pushed in from the space 16 inside the main casing 10 along a corresponding holding thin slot 17 on the wall, and press the clamping section 31, contact section 32, first connecting section 33, and second connecting section 34 of the first conducting plate 30 into one of the positioning slots 19. As the inside of the positioning slot 19 is formed with a wall that matches the first conducting plate 30, the middle tilted plate 321 and lateral tilted plate 322 of the contact section 32, the lateral tilted plate 332 of the first connecting section 33, and the lateral tilted plate 341 of the second connecting section 34 of the first conducting plate 30 can all be clasped on the inside wall of the positioning slot 19, as shown in FIGS. 3 and 4. Meanwhile, the pressing plate 361 extended from the two sides of the bottom section 36 can be clasped on the two side walls of the holding thin slot 17. Thus, the first conducting plate 30 can be fixed and will not fall out. Now, the clamping section 31 of the first conducting plate 30 is suspended in the upper space of the positioning slot 19, in a free state under no force. Meanwhile, the conducting plate 35 and the two conducting flange 351 are extended into the space 16, as shown in FIG. 9.

Then, the second conducting plate 40 is pushed in from the space 16 inside the main casing 10 along the other corresponding holding thin slot 17 on the wall, so that the clamping section 41, contact section 42, first connecting section 43, and second connecting section 44 of the second conducting plate 40 are all pushed into the other positioning slot 19. As the inside of the positioning slot 19 is formed with a wall that matches the second conducting plate 40, the middle tilted plate 421 and lateral tilted plate 422 of the contact section 42, and the lateral tilted plate 432 of the first connecting section 43 of the second conducting plate 40 are all clasped on the internal wall of the positioning slot 19, as shown in FIGS. 3 and 4. Thus, the second conducting plate 40 is fixed and cannot fall out. Now, the clamping section 41 of the second conducting plate 40 is suspended in the upper space of the positioning slot 19 in a free state under no force. Meanwhile, the conducting plate 45 and the two conducting flanges 451 will enter the space 16 in a tilted position, in a free state under no force, as shown in FIG. 9.

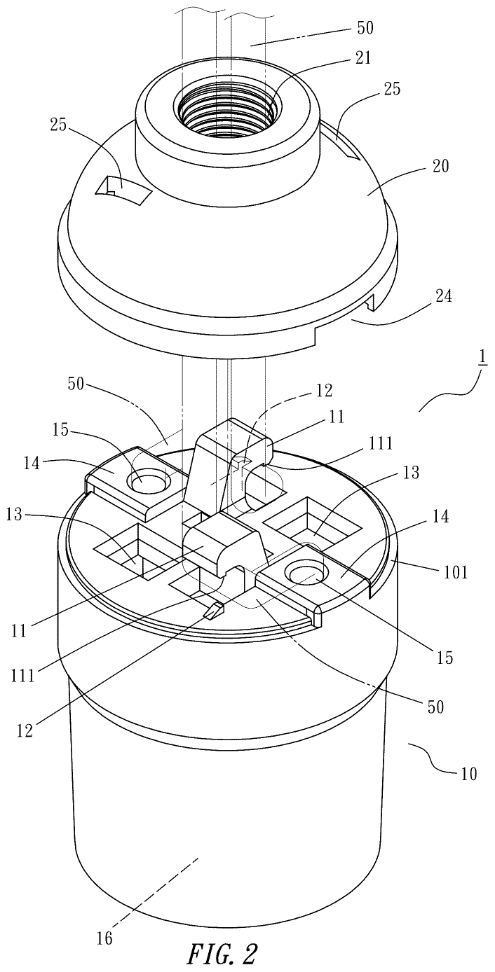

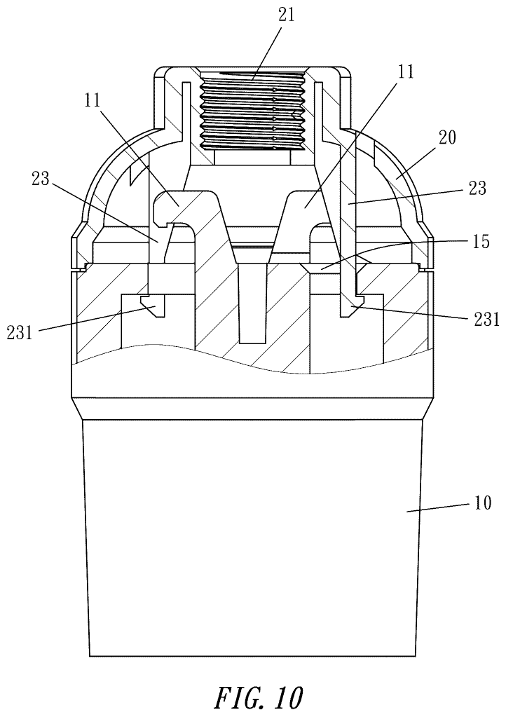

After the main casing 10 and the first and second conducting plates 30, 40 are assembled together, align the space 22 on the bottom of the cover casing 20 to the top of the main casing 10, and make adjustment so that the positioning slot 24 of the cover casing 20 is aligned to the positioning blocks 14 of the main casing 10, and the positioning shield 201 of the cover casing 20 is aligned to the concave shield 101 of the main casing 10. Then, cover the cover casing 20 onto the main casing 10, and fit the concave shield 101 with the positioning shield 201. During this process, the catching bars 23 of the cover casing 20 will be correspondingly inserted into the catching slot 13 of the main casing 10. When the catching hook 231 on the bottom end of the catching bars 23 goes downward and passes the wall of the catching slot 13, as shown in FIG. 10, the catching hook 231 on the bottom of the catching bars 23 will be hooked on the wall of the catching slot 13. Thus, the cover casing 20 and the main casing 10 are firmly coupled. To release the cover casing 20 from the main casing 10, the user can insert a pointed tool into the through slot 25 of the cover casing 20 from the top, and apply a force to press the lower section of the catching bars 23, forcing the catching hook 231 of the catching bars 23 to be separated from the wall of the catching slot 13. In this way, the cover casing 20 and the main casing 10 can be separated from each other. When the pair of catching bars 23 is released, the cover casing 20 can be separated from the main casing 10 and be recovered to the state shown in FIGS. 2 and 4.

As described above, the cover casing 20 and the main casing 10 can either be firmly assembled together or be separated from each other as needed. Before using the switchless lamp holder 1 of the present invention, a power cord must be connected in advance. As shown in FIGS. 2 and 9, a small section of the end of a power cord 50 connecting commercial power supply must be firstly be stripped to form a naked section. Then, the naked section of the power cord 50 is extended from outside the cover casing 20 through the connecting slot 21 and the space 22. Then, the two lines of the power cord 50 are separated, and respectively winded under the hooks 11 of the main casing 10 and be pressed by the hook 11. Meanwhile, the power cord 50 will be limited between the assisting hook 111 and the retaining edge 12, i.e., the assisting hook 111 and the retaining edge 12 will assist the hook 11 to limit the position of the power cord 50 and prevent it from falling out. Then, the stripped section of the power cord 50 can be inserted downward into the corresponding plug hole 15. The stripped sections of the two power cords 50 will respectively contact the clamping section 31 of the first conducting plate 30 and the clamping section 41 of the second conducting plate 40. Now, apply a force to insert the stripped section of the power cord 50 further into the corresponding plug hole 15. The stripped section of the power cord 50 will respectively press apart the clamping section 31, 41 and go further into the hole. The recovering force of the clamping section 31, 41 will cause the concave contact slot 311, 411 to firmly press the stripped section of the power cord 50. Now, the power cord is perfectly connected to the main casing 10, and the cover casing 20 and the main casing 10 can be coupled in the way disclosed above.

After the switchless lamp holder 1 is connected to commercial electric power supply, a lighting component (such as a bulb) can be threaded in, as shown in FIG. 9. The lighting component (such as a bulb) has a ring-threaded head 60 with its threads corresponding to the lateral thread convex body 18 of the main casing 10. Therefore, when the ring-threaded head 60 of the lighting component is threaded in from the space 16 on the bottom of the main casing 10, the threads of the ring-threaded head 60 is gradually engaged with the lateral thread convex body 18 of the main casing 10, driving the ring-threaded head 60 to gradually rise inside the space 16. During the process, the ring-threaded head 60 is electrically conducted with the conducting flanges 351 of the first conducting plate 30 on one pole. Then, when the top end 61 of the ring-threaded head 60 moves further up and touches the conducting flanges 451 of the conducting plate 45, the user can apply a force to continuously lift the ring-threaded head 60, and the top end 61 of the ring-threaded head 60 will push the conducting flanges 451 to force the conducting plate 45 to bend upward till the conducting flanges 451 is resisted by the above structure. Now, the ring-threaded head 60 and the lateral thread convex body 18 are firmly coupled. Meanwhile, the top end 61 of the ring-threaded head 60 is conducted with the conducting flanges 451 of the second conducting plate 40 on the other pole. Because the ring-threaded head 60 and the top end 61 are insulated, after the ring-threaded head 60 and the top end 61 are conducted on different poles, electric power can be supplied to the lighting component (such as a bulb).

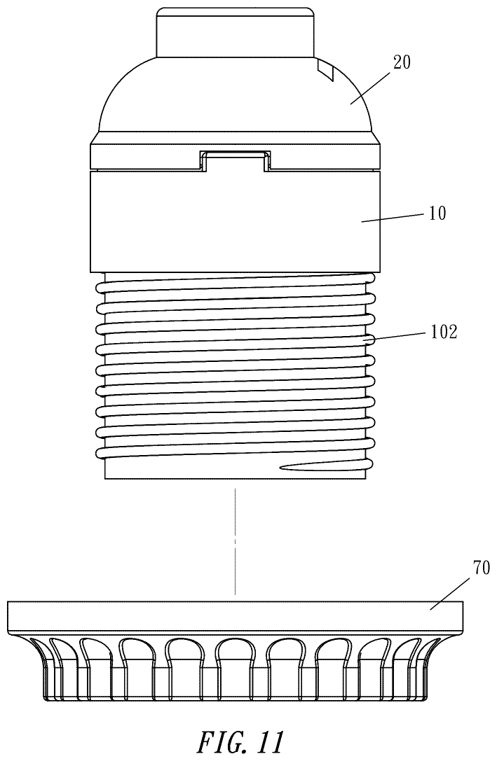

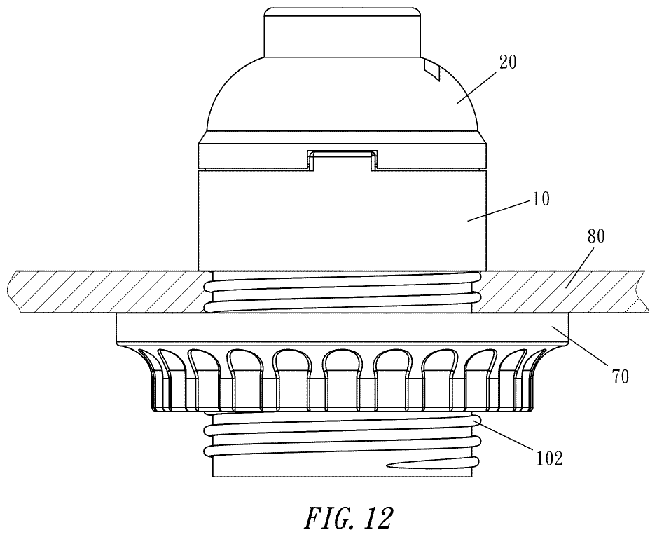

The structure, assembly, power connection, and usage of the switchless lamp holder 1 are described above. When assembled, the connecting slot 21 on the top of the cover casing 20 can be threaded with a supporter. When supported by the supporter, the switchless lamp holder 1 can be used for suspended lamps. Alternatively, without substantial change, as shown in FIG. 11, the outer wall of the main casing 10 can be configured with an external thread section 102, for connection with a locking component 70 configured with internal threads. In use, as shown in FIG. 12, a plate body 80 having a hole can be provided for the external thread section 102 of the switchless lamp holder 1 to go through and be positioned. Then, the locking component 70 can be threaded in from the bottom and be coupled with the external thread section 102, thus fastening the switchless lamp holder 1 and the plate body 80. If the plate body 80 is a ceiling, after the switchless lamp holder 1 is coupled with the lighting component (such as a bulb), a ceiling lamp is formed. If the plate body 80 is a lamp shade, after a lighting component (such as a bulb) is connected, a desk lamp can be formed. All such varied applications shall be covered by the scope of the present invention.

As described above, the present invention combines the hook 11, the assisting hook 111 and the retaining edge 12 to limit the position of the power cord 50 and prevent it from falling apart. Meanwhile, by providing the first and second conducting plates 30, 40 stably installed inside the positioning slot 19 of the main casing 10, the power cord 50 introduced from the plug hole 15 into the positioning slot 19 can be firmly clamped. Thus, the position of the power cord 50 is limited, and the power cord 50 is firmly clamped. As the power cord 50 cannot be separated from the first and second conducting plates 30, 40, safe use of electricity can be ensured.

In summary, the present invention not only has novelty, but also has value for industrial utilization. Therefore, an application for invention patent is submitted. Your examination and approval will be highly appreciated.

What is claimed is:

1. A switchless lamp holder, comprising:
a main casing made of a non-conductive material, having a pair of hooks vertically configured inside a top surface, an assisting hook formed on a front edge of a bottom of the hook, a retaining edge configured on the top surface of the main casing corresponding to the front of the hook, a catching slot configured on an adjacent side of each hook, a pair of positioning blocks convexly and correspondingly configured on the top surface of the main casing closed to a peripheral edge, a downward through plug hole configured on each positioning block, an interior of the main casing hollowed downward to form a space, a pair of holding thin slots concavely configured on the wall inside the space in an interlaced and corresponding arrangement and correspondingly configured with a pair of lateral thread convex bodies, the threads of the corresponding thread convex bodies being continuous and a positioning slot formed under each plugs hole;
a cover casing made of a non-conductive material, having a downward through connecting slot configured in a middle of a top edge, a bottom of the cover casing hollowed downward to form a space, a pair of catching bars downward and vertically configured inside the space corresponding to the two sides of the connecting slot, the bottom end of the catching bars formed with a catching hook, the catching bar and the said catching slot corresponding to each other, a pair of positioning slots concavely and corresponding configured on the bottom edge of the cover casing, the positioning slot corresponding to the said positioning block, while assembling, the space on the bottom of the cover casing aligning the top surface of the main casing to cover, enabling the positioning slot of the cover casing to align the positioning block of the main casing and meanwhile, the catching bar of the cover casing being inserted into the catching slot of the main casing, the catching hook on the bottom of the catching bar being hooked on the wall of the catching slot to enable the cover casing and the main casing to be engaged;
a first conducting plate made of a conductive material, having a slightly tilted clamping section, wherein a middle of a front end concavely provided with a concave contact slot and a tail end bending downward to form a contact section, a middle part tilting backward to form a middle tilted plate and the two sides tilting forward to form a lateral tilted plate, a bottom end of the contact section tilting forward to form a first connecting section, wherein two sides respectively tilting downward to form a lateral tilted plate, a tail end of the first connecting section bending downward to form a second connecting section, wherein two sides respectively tilting forward to form a lateral tilted plate, a bottom edge of the second connecting section tilting backward and shrinking to further extend vertically downward to form a conducting plate having a pair of conducting flanges protruding backward, the bottom edge of the conducting plate tilting forward and further extending vertically downward to form a bottom section, the two sides of the bottom edge respectively extending to form a pressing plate, and while assembling, the first conducting plate being pushed in from the space inside the main casing along a corresponding holding thin slot on the wall, enabling the clamping section, the contact section, the first connecting section and the second connecting section of the first conducting plate to enter into the positioning slot and clamp with an internal wall, and meanwhile, the pressing plate extending from the two sides of the bottom section clamping with the two side walls of the holding thin slot, enabling the first conducting plate to be fixed, the clamping section of the first conducting plate resting inside an upper section space of the positioning slot, and meanwhile the conducting plate and the conducting flanges protruding into the space of the main casing; and,
a second conducting plate made of a conductive material, having a slightly tilted clamping section, wherein a middle of a front end concavely provided with a contact slot, a tail end bending downward to form a contact section, a middle part tilting backward to form a middle tilted plate and the two sides respectively tilting forward to form a lateral tilted plate, a bottom end of the contact section tilting forward to form a first connecting section, wherein the two sides respectively tilting downward to form a lateral tilted plate, a tail end of the first connecting section bending downward to form a second connecting section, a bottom edge of the second connecting section tilting backward to form a conducting plate, wherein a surface protruding downward to form a conducting flange protruding, while assembling, the second conducting plate being pushed into from the space inside the main casing along the other corresponding holding thin slot on the wall, enabling the clamping section, the contact section, the first connecting section and the second connecting section of the second conducting plate entering into the other positioning slot and clamp with the internal wall, and meanwhile the conducting plate and the conducting flange entering into the space of the main casing.

2. The switchless lamp holder of claim 1, wherein a top periphery of the main casing is concavely configured with a ring of a concave shield, the concave shield is disconnected when reaching the positioning blocks, a bottom periphery of the cover casing is configured with a ring of a positioning shield, the positioning shield is disconnected when reaching the positioning slot, and when the cover casing covers the main casing, the concave shield correspondingly fits the positioning shield.

3. The switchless lamp holder of claim 1, wherein a pair of through slots are configured on the cover casing on the outer side of the catching bars, allowing a tool to go through the through slot and apply a force to release the catching bars from the catching slot, so as to separate the cover casing from the main casing.
